(19) United States
(12) Patent Application Publication
(10) Pub. No.: US 2026/0018904 A1
(43) Pub. Date: Jan. 15, 2026

(54) POWER OUTPUT METHOD AND APPARATUS FOR GENERATOR, GENERATOR, AND POWER GENERATION AND ENERGY STORAGE SYSTEM

(71) Applicant: ECOFLOW INC., Shenzhen (CN)

(72) Inventors: Fei WANG, Shenzhen (CN); Xi CHEN, Shenzhen (CN); Lei WANG, Shenzhen (CN)

(21) Appl. No.: 19/337,271

(22) Filed: Sep. 23, 2025

Related U.S. Application Data
(63) Continuation of application No. PCT/CN2024/082553, filed on Mar. 20, 2024.

(30) Foreign Application Priority Data
Mar. 24, 2023 (CN) 202310352156.5

(51) Int. Cl. H02J 7/00; H02J 7/14

(52) U.S. Cl. CPC H02J 7/00036; H02J 7/0068; H02J 7/14

(57) ABSTRACT

A power output method for a generator includes: when it is detected that an energy storage device is connected, obtaining required power of the energy storage device; sending a first inquiry instruction to the energy storage device, where the first inquiry instruction is used to inquire whether the energy storage device consents to switching of the required power to rated generating power, the rated generating power being corresponding power used when fuel utilization of a generator reaches preset fuel utilization; and when receiving a first consent signal fed back by the energy storage device, generating power using the rated generating power as target generating power, to supply power to the energy storage device; or when receiving a first rejection signal fed back by the energy storage device, generating power using the required power as target generating power, to supply power to the energy storage device.

### CROSS-REFERENCE TO RELATED APPLICATIONS

This application is a continuation application of PCT patent application No. PCT/CN2024/082553, filed on Mar. 20, 2024, which claims priority to Chinese Patent Application No. 2023103521565, filed on Mar. 24, 2023, all of which is incorporated herein by reference in their entirety.

### TECHNICAL FIELD

The present application relates to the field of power generation technologies, and in particular, to a power output method and apparatus for a generator, a generator, and a power generation and energy storage system.

### BACKGROUND

When a generator supplies power to a load at a rated speed, power output by the generator is rated power. When the generator operates near the rated power (in an efficient operation power range), a fuel can be utilized efficiently with a high fuel conversion rate.

However, actual output power of the generator is determined by the connected load. When power required by the load is less than the rated power of the generator, or power required by the load is greater than the rated power of the generator, the generator often does not operate in the efficient operation power range. As a result, fuel utilization is low, and energy is wasted.

### SUMMARY

According to various embodiments of the present application, a power output method and apparatus for a generator, a generator, and a power generation and energy storage system are provided.

An embodiment of the present application provides a power output method for a generator. The method includes:
when it is detected that an energy storage device is connected to a generator, obtaining required power of the energy storage device;
sending a first inquiry instruction to the energy storage device, where the first inquiry instruction is used to inquire whether the energy storage device consents to switching of the required power to rated generating power, the rated generating power being corresponding power used when fuel utilization of the generator reaches preset fuel utilization; and
when receiving a first consent signal fed back by the energy storage device, generating power using the rated generating power as target generating power, to supply power to the energy storage device; or
when receiving a first rejection signal fed back by the energy storage device, generating power using the required power as target generating power, to supply power to the energy storage device.

An embodiment of the present application provides a power output apparatus for a generator. The apparatus includes a processor and a memory. The memory stores a computer program. The processor is configured to perform the foregoing power output method for a generator by invoking the computer program stored in the memory.

An embodiment of the present application provides a generator. The generator includes the foregoing power output apparatus for a generator.

An embodiment of the present application provides a power generation and energy storage system, including an energy storage device and the foregoing generator.

The generator is electrically connected to the energy storage device, and is configured to charge the energy storage device.

Details of one or more embodiments of the present application will be proposed in the following drawings and descriptions. Other features, objectives, and advantages of the present application will become apparent in the specification, the drawings, and the claims.

### BRIEF DESCRIPTION OF THE DRAWINGS

To describe the technical solutions in the embodiments of the present application more clearly, the following briefly describes the accompanying drawings required for describing the embodiments. Apparently, the accompanying drawings in the following description show some embodiments of the present application, and a person of ordinary skill in the art may derive other drawings from these accompanying drawings without creative efforts.

FIG. 1 is a diagram of an application scenario of a power output method for a generator according to an embodiment of the present application;

FIG. 2 is a diagram of an application scenario of another power output method for a generator according to an embodiment of the present application;

FIG. 3 is a schematic flowchart of a power output method for a generator according to an embodiment of the present application;

FIG. 4 is a schematic flowchart of another power output method for a generator according to an embodiment of the present application;

FIG. 5 is a schematic flowchart of still another power output method for a generator according to an embodiment of the present application;

FIG. 6 is a schematic flowchart of yet another power output method for a generator according to an embodiment of the present application; and

FIG. 7 is a schematic block diagram of a structure of a power output apparatus for a generator according to an embodiment of the present application.

### DETAILED DESCRIPTION

The following clearly and completely describes the technical solutions in the embodiments of the present application with reference to the accompanying drawings in the embodiments of the present application. Apparently, the described embodiments are a part but not all of the embodiments of the present application. All other embodiments obtained by a person of ordinary skill in the art based on the embodiments of the present application without creative efforts shall fall within the protection scope of the present application.

The flowcharts shown in the accompanying drawings are merely exemplary descriptions, do not need to include all content and operations/steps, and do not need to be performed in the described orders either. For example, some operations/steps may be further divided, combined, or partially combined. Therefore, an actual execution order may change based on an actual situation.

It should be noted that the terms “first”, “second”, and the like in the specification, claims, and drawings of the present application are intended to distinguish between similar objects but do not describe a specific order or sequence.

It should be understood that terms used in the specification of the present application are only for the purpose of describing specific embodiments, and are not intended to limit the present application. The terms “a/an”, “one”, and “this” of singular forms used in the specification and the appended claims of the present application are intended to include plural forms, unless otherwise specified in the context clearly.

The following describes some embodiments with reference to the accompanying drawings. In absence of conflicts, the following embodiments and features in the embodiments may be combined.

The embodiments of the present application provide a power output method and apparatus for a generator, a generator, and a power generation and energy storage system.

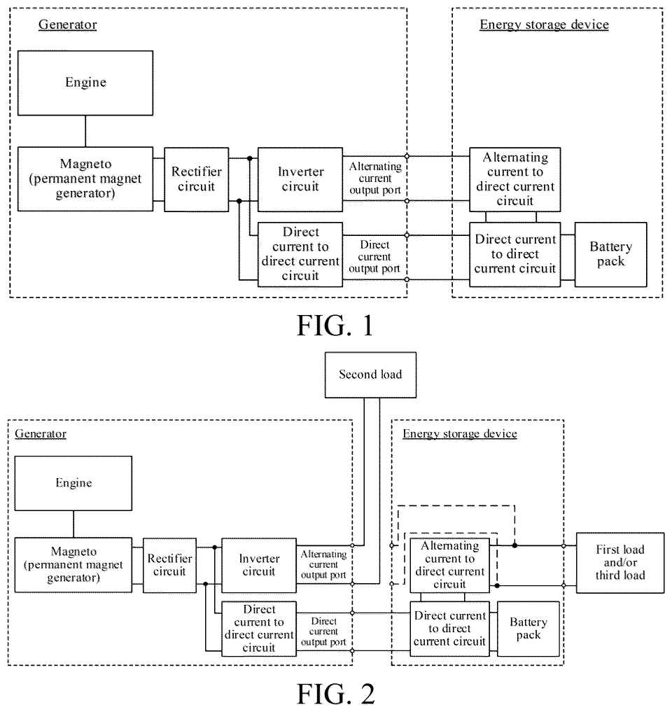

Refer to FIG. 1. FIG. 1 is a diagram of an application scenario of a power output method for a generator according to an embodiment of the present application.

As shown in FIG. 1, the power output method for a generator may be applied to a generator. The generator may be a device including a power generation function and a power supply function. For example, the generator includes a diesel generator, a gasoline generator, a gas generator, permanent magnet generator, a wind generator, and a hydroelectric generator. The generator may be configured to be connected to an energy storage device. For example, the generator may convert energy in another form into electric energy via an engine, a magneto, a rectifier circuit, an inverter circuit, and a direct current (DC) to direct current circuit, to supply power to the energy storage device connected to the generator. The inverter circuit may be an INV circuit (inverter). The inverter is an apparatus that converts a direct current (DC) into an alternating current (AC). The inverter usually includes an inverter bridge, control logic, and a filter circuit. For example, the generator may output power to the energy storage device through an alternating current output port or a direct current output port. When the generator needs to supply power to the energy storage device, the generator may determine target generating power according to the power output method for a generator, and the generator is controlled to generate power at the target generating power to supply power to the energy storage device. The energy storage device may include a direct current to direct current circuit, an alternating current to direct current circuit, and a battery pack. The direct current to direct current circuit is configured to be connected to the direct current output port of the generator. The direct current to direct current circuit is configured to perform direct current to direct current conversion on a direct current output by the generator, and output the direct current to the battery pack to charge the battery pack. The alternating current to direct current circuit is configured to be connected to the alternating current output port of the generator. The alternating current to direct current circuit is configured to perform alternating current to direct current conversion on an alternating current output from the alternating current output port, and output a direct current to the battery pack to charge the battery pack.

As shown in FIG. 1 and FIG. 2, the power output method for a generator may be applied to a power output apparatus for a generator. For example, the power output apparatus for a generator is disposed in a generator. The power output apparatus for a generator may supply power to a device connected to the generator. The device connected to the generator includes, for example, an energy storage device and a load (for example, a first load, a second load, and a third load) other than the energy storage device. When the generator needs to supply power to the connected device, for example, the energy storage device, the power output apparatus for a generator may determine target generating power according to the power output method for a generator, and the generator is controlled to generate power at the target generating power. Alternatively, the power output method for a generator may be applied to a power generation and energy storage system. For example, the power generation and energy storage system includes an energy storage device and a generator, where the generator is electrically connected to the energy storage device. For example, the generator in the power generation and energy storage system may output power to the energy storage device in the power generation and energy storage system through an alternating current (AC) output port or a direct current (DC) output port. When the generator in the power generation and energy storage system needs to supply power to the energy storage device in the power generation and energy storage system, the generator may determine target generating power according to the power output method for a generator, and the generator is controlled to generate power at the target generating power.

In some implementations, after the target generating power of the generator is determined according to the power output method for a generator, the generator may continuously generate power at the target generating power. For example, the generator may be controlled using a control loop combining a power loop and a current loop, to continuously generate power at the target generating power. Certainly, this is not limited thereto, and no limitation is imposed herein.

The power output method for a generator includes: when it is detected that the energy storage device is connected to the generator, obtaining required power of the energy storage device; sending, by the generator, a first inquiry instruction to the energy storage device, where the first inquiry instruction is used to inquire whether the energy storage device consents to switching of the required power to rated generating power, the rated generating power being corresponding power used when fuel utilization of the generator reaches preset fuel utilization; and when receiving a first consent signal fed back by the energy storage device, generating power using the rated generating power as the target generating power, to supply power to the energy storage device; or when receiving a first rejection signal fed back by the energy storage device, generating power using the required power as the target generating power, to supply power to the energy storage device.

For example, after the required power of the energy storage device is obtained, it is determined that the required power is not efficient operation power of the generator corresponding to a fuel-efficient operation region, for example, the required power is inconsistent with the rated generating power. It may be understood that the rated generating power may be a constant value or a range. When the rated generating power is a range, if the required power does not fall within any rated generating power range, it is considered that the required power is inconsistent with the rated generating power. In this case, the rated generating power is sent to the energy storage device, and during communication with the energy storage device, the energy storage device selects whether to accept power supply to the energy storage device at the rated generating power. When the energy storage device accepts power supply at the rated generating power, power is generated using the rated generating power of the generator as the target generating power, and is transmitted to the energy storage device using the target generating power as output power, to charge the energy storage device. Because the rated generating power is the corresponding power used when the fuel utilization of the generator reaches the preset fuel utilization, the generator can operate efficiently when charging the energy storage device. Therefore, the fuel utilization can be improved, and energy can be saved.

The following describes in detail some embodiments of the present application with reference to the accompanying drawings. In absence of conflicts, the following embodiments and features in the embodiments may be combined.

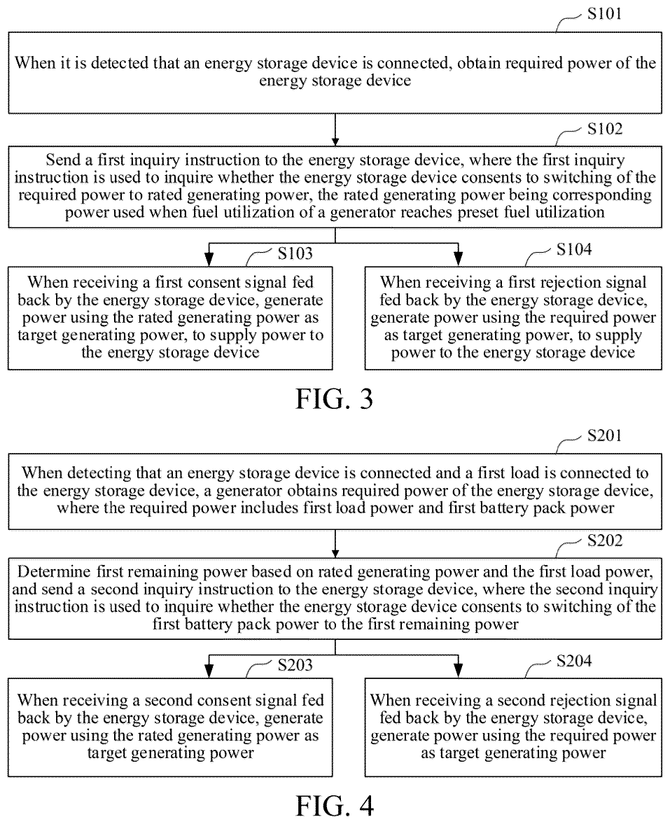

Refer to FIG. 3. FIG. 3 is a schematic flowchart of a power output method for a generator according to an embodiment of the present application.

As shown in FIG. 3, the power output method for a generator includes S101 to S104.
S101: When it is detected that an energy storage device is connected to a generator, obtain required power of the energy storage device.

For example, the generator may be configured to be connected to the energy storage device, to supply power to the energy storage device. For example, the generator may be connected to the energy storage device through an alternating current output port or a direct current output port. When it is detected that the energy storage device is connected to the generator, the generator may communicate with the energy storage device. For example, the generator may communicate with the energy storage device in a manner of a controller area network (CAN), a programmable logic controller (PLC), or wireless communication. When the generator communicates with the energy storage device, the generator may receive the required power sent by the energy storage device. For example, the required power includes a required charging power range for the energy storage device, a required charging voltage range for the energy storage device, and a required charging current range for the energy storage device, and certainly, is not limited thereto. For another example, the required power of the energy storage device includes a required charging power value for the energy storage device, a required charging voltage value for the energy storage device, and a required charging current value for the energy storage device. This is not limited herein.

For example, when the generator receives the required power sent by the energy storage device, during a subsequent process of supplying power to the energy storage device, the generator may determine target generating power of the generator based on the required power of the energy storage device, to supply power to the energy storage device. When it is detected that the energy storage device is connected to the generator, the required power of the energy storage device is obtained, to subsequently determine the target generating power of the generator.
S102: Send a first inquiry instruction to the energy storage device, where the first inquiry instruction is used to inquire whether the energy storage device consents to switching of the required power to rated generating power, the rated generating power being corresponding power used when fuel utilization of the generator reaches preset fuel utilization.

For example, the rated generating power may be a rated generating power value or a rated generating power range. For example, the rated generating power may include 3 kilowatts, where 3 kilowatts may be referred to as 3 KW for short. Alternatively, the rated generating power may include [3 kW-ΔP, 3 KW], where ΔP represents a power difference. Alternatively, the rated generating power may be a range. For example, when the generator has a plurality of fuel-efficient operation regions, different numbers of fuel-efficient operation regions correspond to different rated generating power. For example, the rated generating power may be [1 kW, 2 KW]∪[2.5 KW, 3.5 kW]∪[4 kW, 5 KW], which may be set based on an actual situation. This is not limited herein.

For example, the generator may have at least one piece of rated generating power. When the generator supplies power to a load device, for example, the energy storage device at the rated generating power, the fuel utilization of the generator reaches the preset fuel utilization. Correspondingly, the preset fuel utilization may be a fuel utilization value. Alternatively, the preset fuel utilization may be a fuel utilization range. For example, the preset fuel utilization may include 85%, or may include 75% to 100%. In some implementations, when the fuel utilization of the generator reaches the preset fuel utilization, it may be determined that the fuel utilization of the generator is high, which is equivalent to that the generator operates in a fuel-efficient operation region. Therefore, the rated generating power is also referred to as, for example, efficient operation power corresponding to the fuel-efficient operation region. The generator may have one or more fuel-efficient operation regions. A number of efficient operation regions or the efficient operation power corresponding to the efficient operation region may be determined based on an engine in the generator, a generator model, and the like. This is not limited herein.

In some implementations, after obtaining the required power of the energy storage device, the generator may, for example, determine whether the required power of the energy storage device is the efficient operation power of the generator corresponding to the fuel-efficient operation region, that is, determine whether the required power of the energy storage device matches the rated generating power.

When the required power of the energy storage device is not the efficient operation power of the generator corresponding to the fuel-efficient operation region, that is, the required power of the energy storage device does not match the rated generating power, it may be determined that when the generator supplies power to the energy storage device at the required power of the energy storage device, it is likely to cause low fuel utilization and fuel waste because the preset fuel utilization is not reached. However, the required power of the energy storage device is optimal safe charging power for the energy storage device. For example, when power is supplied to the energy storage device at the required power of the energy storage device, the energy storage device can be fully charged safely within a shortest time. However, some energy storage devices can be safely charged not at the required power, but require long charging time. Therefore, some energy storage devices accept charging not at the required power. To maximally control the generator to operate at the rated generating power, the fuel utilization is maximally improved. The generator may send the first inquiry instruction to the energy storage device to inquire whether the energy storage device consents to switching of the required power to the rated generating power. For example, the first inquiry instruction may be used to inquire whether the energy storage device consents to switching of the required power to a rated generating power value. Alternatively, the first inquiry instruction may be used to inquire whether the energy storage device consents to switching of the required power to a rated generating power range. Certainly, this is not limited thereto, and no limitation is imposed herein. When receiving the first inquiry instruction, the energy storage device may make a selection based on an actual situation.

The first inquiry instruction is sent to the energy storage device, where the first inquiry instruction is used to inquire whether the energy storage device consents to switching of the required power to the rated generating power, so that the energy storage device may select, based on the actual situation, whether to switch the required power to the rated generating power. Sending the first inquiry instruction to the energy storage device helps improve convenience and flexibility in interaction about power for power supply to the energy storage device by the generator. In addition, the generator can subsequently determine the power for power supply to the energy storage device based on the selection of the energy storage device, helping subsequently improve convenience in determining the power for power supply to the energy storage device by the generator.

In an embodiment, after obtaining the required power of the energy storage device, the generator may not determine whether the required power of the energy storage device is the efficient operation power of the generator corresponding to the fuel-efficient operation region, that is, directly sends the first inquiry instruction to the energy storage device. It may be understood that when the required power matches the rated generating power, the first inquiry instruction is used to inquire whether the energy storage device consents to switching of the required power to the rated generating power. In this case, the required power is consistent with the rated generating power. When the required power does not match the rated generating power, the first inquiry instruction is used to inquire whether the energy storage device consents to switching of the required power to the rated generating power. In this case, the required power is inconsistent with the rated generating power.
S103: When receiving a first consent signal fed back by the energy storage device, generate power using the rated generating power as target generating power, to supply power to the energy storage device.

For example, when receiving the first inquiry instruction sent by the generator, the energy storage device may feed back information to the generator. The information fed back may include the first consent signal. The first consent signal is used to indicate that the energy storage device consents to switching of the required power to the rated generating power. It may be understood that when the information fed back is the first consent signal, it indicates that the energy storage device may accept power supply to the energy storage device by the generator at the rated generating power.

In some implementations, when the first inquiry instruction is used to inquire whether the energy storage device consents to switching of the required power to a rated generating power value, if the energy storage device selects to consent to switching of the required power to the rated generating power value, it may be determined that the energy storage device feeds back the first consent signal to the generator. For example, the first consent signal carries the rated generating power value. When the first inquiry instruction is used to inquire whether the energy storage device consents to switching of the required power to a rated generating power range, if the energy storage device selects to consent to switching of the required power to the rated generating power range, or the energy storage device selects at least one new rated generating power value or at least one new rated generating power range from the rated generating power range to indicate that the energy storage device consents to switching of the required power to the rated generating power range, it may be determined that the energy storage device feeds back the first consent signal to the generator. For example, the first consent signal carries the rated generating power range, or the at least one new rated power value or at least one new rated power range in the rated generating power range.

For example, when the generator receives the first consent signal fed back by the energy storage device, the generator may determine that the target generating power is the rated generating power. The generator generates power at the rated generating power, to supply power to the energy storage device. For example, the generator generates power using the at least one rated generating power value or at least one rated power range carried in the first consent signal as the target generating power, to supply power to the energy storage device. Because the target generating power is the efficient operation power of the generator corresponding to the fuel-efficient operation region, that is, the rated generating power, the generator may be controlled to operate at the efficient operation power, improving the fuel utilization.

When receiving the first consent signal fed back by the energy storage device, the generator generates power using the rated generating power as the target generating power, to supply power to the energy storage device. Upon reception of the first consent signal, the generator may be controlled to generate power at the rated generating power, helping improve convenience in controlling the generator to operate at the efficient operation power. In addition, the generator generates power using the rated generating power as the target generating power, helping improve the fuel utilization of the generator and save energy.

S104: When receiving a first rejection signal fed back by the energy storage device, generate power using the required power as target generating power, to supply power to the energy storage device.

For example, when the energy storage device receives the first inquiry instruction sent by the generator, the energy storage device may feed back information to the generator. The information fed back may include the first rejection signal. The first rejection signal is used to indicate that the energy storage device rejects switching of the required power to the rated generating power.

In some implementations, when the first inquiry instruction is used to inquire whether the energy storage device consents to switching of the required power to a rated generating power value, if the energy storage device selects to reject switching of the required power to the rated generating power value, the energy storage device feeds back the first rejection signal to the generator. When the first inquiry instruction is used to inquire whether the energy storage device consents to switching of the required power to a rated generating power range, if the energy storage device selects to reject switching of the required power to the rated generating power range, the energy storage device feeds back the first rejection signal to the generator.

For example, when the generator receives the first rejection signal fed back by the energy storage device, for example, the energy storage device feeds back the first rejection signal because a user has an urgent need to use the energy storage device and charging the energy storage device at low power cannot meet a requirement, or because the energy storage device cannot be charged at high power in a fully charged state or any one state close to a fully charged state, the generator needs to generate power at the required power. To be specific, the generator may determine that the target generating power is the required power, and generate power at the required power, to supply power to the energy storage device.

The generator is configured to generate, after receiving the first rejection signal fed back by the energy storage device, power using the required power as the target generating power, to supply power to the energy storage device, helping meet a charging requirement of the energy storage device and improve experience in using the generator for the energy storage device.

In some implementations, when it is detected that the energy storage device is connected to the generator, and the target generating power of the generator needs to be determined, if the generator directly determines that the target generating power of the generator is the rated generating power without sending the first inquiry instruction to the energy storage device, the generator cannot meet a requirement of the energy storage device for generating power of the generator when operating at the efficient operation power, which is prone to poor experience in using the generator for the energy storage device; or if the generator directly determines that the target generating power of the generator is the required power without sending the first inquiry instruction to the energy storage device, the generator cannot operate at the efficient operation power while meeting a requirement of the energy storage device for power of the generator, which is prone to low fuel utilization of the generator and energy waste.

In the method used in this embodiment of the present application, based on the setting of the first inquiry instruction, the first consent signal, and the first rejection signal, the energy storage device may select, based on the actual situation, to feed back the first consent signal or the first rejection signal corresponding to the first inquiry instruction to the generator, to flexibly select the target generating power of the generator, so that the generator can be controlled to operate at the target generating power required by the energy storage device. For example, when receiving the first consent signal fed back by the energy storage device, it may be determined that the rated generating power is the efficient operation power of the generator corresponding to the fuel-efficient operation region. In addition, the rated generating power is also the required power of the energy storage device, so that setting the rated generating power to generate power for the energy storage device helps improve convenience in controlling the generator to operate at the efficient operation power. Setting the rated generating power to generate power for the energy storage device further helps improve the fuel utilization to save energy and meet the charging requirement of the energy storage device, to improve the experience in using the generator for the energy storage device.

For example, as shown in FIG. 2, the energy storage device may be configured to be connected to a first load. When the energy storage device is connected to the generator, and the first load is connected to the energy storage device, for example, the energy storage device may be connected to both the alternating current output port and the direct current output port of the generator. In this case, the energy storage device enables a bypass function, so that the generator supplies power to the battery pack in the energy storage device through the direct current output port, and the generator supplies power to the first load through the alternating current output port. When the generator supplies power to the energy storage device and the first load, the required power of the energy storage device not only includes required power of the battery pack in the energy storage device, a circuit in the energy storage device, or the like, but also includes required power of the first load.

For example, the required power of the energy storage device may be determined based on power of the battery pack in the energy storage device, so that the required power of the energy storage device may be referred to as first battery pack power. Correspondingly, the required power of the first load may be referred to as first load power corresponding to the first load.

In some implementations, if the required power includes the first load power and the first battery pack power, the generator may determine first remaining power based on the rated generating power and the first load power. Then, the generator sends a second inquiry instruction to the energy storage device, where the second inquiry instruction is used to inquire whether the energy storage device consents to switching of the first battery pack power to the first remaining power.

When the first load is connected to the energy storage device, it may be determined that the user needs the energy storage device to supply power to the first load, which is equivalent to that a charging requirement of the first load is prior to that of the energy storage device. In this case, the generator preferentially supplies power to the first load when supplying power to the energy storage device and the first load. In addition, to maximally control the generator to operate at the efficient operation power, actual power, for example, the first remaining power, allocable to the first battery pack in the energy storage device when the generator operates at the rated generating power may be determined based on the rated generating power and the first load power. It may be understood that the first remaining power is obtained by subtracting the first load power from the rated generating power, that is, the rated generating power preferentially meets a power supply requirement of the first load. The first remaining power may include a first remaining power value, or may include a first remaining power range. This is not limited herein.

For example, the first remaining power is obtained by subtracting the first load power from the rated generating power of the generator. Based on the determination of the first remaining power, the generator sends the second inquiry instruction to the energy storage device, to inquire whether the energy storage device consents to switching of the first battery pack power to the first remaining power. If the energy storage device consents to switching of the first battery pack power to the first remaining power, a sum of the first load power and the first battery pack power is the rated generating power. This helps control the efficient operation power of the generator corresponding to the fuel-efficient operation region, improve the fuel utilization of the generator, and save energy.

The first remaining power is determined, and the second inquiry instruction is sent to the energy storage device, so that the energy storage device may select, based on an actual situation, whether to switch the first battery pack power to the first remaining power, helping improve the convenience and the flexibility in interaction for determining the power for power supply to the energy storage device by the generator. In addition, the generator can subsequently determine power for power supply to the energy storage device and the first load based on the selection of the energy storage device, helping improve convenience for the power for power supply to the energy storage device and the first load by the generator.

In some implementations, when receiving a second consent signal fed back by the energy storage device, the generator generates power using the rated generating power as the target generating power.

For example, when receiving the second inquiry instruction sent by the generator, the energy storage device may feed back information to the generator. The information fed back may include the second consent signal. The second consent signal is used to indicate that the energy storage device consents to switching of the first battery pack power to the first remaining power.

For example, when receiving the second consent signal fed back by the energy storage device, the generator may switch the first battery pack power to the first remaining power, which is equivalent to that a sum of the first remaining power and the first load power is the rated generating power. In this case, the generator may determine that the target generating power is the rated generating power, and generate power at the rated generating power, to supply power to the energy storage device and the first load. In this way, the generator generates power at the rated generating power. The first load power is used to supply power to the first load. The first remaining power is used to charge the first battery pack in the energy storage device. According to the foregoing method, the generator can operate at the efficient operation power, helping improve the fuel utilization and save energy.

When receiving the second consent signal fed back by the energy storage device, the generator generates power using the rated generating power as the target generating power. Upon reception of the second consent signal, the generator may be controlled to generate power at the rated generating power, helping improve convenience in controlling the generator to operate at the efficient operation power. In addition, the generator generates power using the rated generating power as the target generating power, helping improve the fuel utilization of the generator and save energy.

In some implementations, when a second rejection signal fed back by the energy storage device is received, power is generated using the required power as the target generating power.

For example, when receiving the second inquiry instruction sent by the generator, the energy storage device may feed back information to the generator. The information fed back may include the second rejection signal. The second rejection signal is used to indicate that the energy storage device rejects switching of the first battery pack power to the first remaining power. The first remaining power may include the first remaining power value, or may include the first remaining power range. This is not limited herein.

For example, when the generator receives the second rejection signal fed back by the energy storage device, for example, the energy storage device feeds back the second rejection signal because the user has an urgent need to use the energy storage device and charging the energy storage device at low power cannot meet the requirement, or because the energy storage device cannot be charged at high power in the fully charged state or any state close to the fully charged state, the generator may determine that the target generating power is the required power, and generate power at the required power, to supply power to the first battery pack in the energy storage device and the first load.

When receiving the second rejection signal fed back by the energy storage device, power is generated using the required power as the target generating power, to supply power to the first battery pack in the energy storage device and the first load. According to the foregoing method, upon reception of the second rejection signal, the generator may be controlled to generate power at the required power, helping meet the charging requirements of the energy storage device and the first load, to improve the experience in using the generator for the energy storage device and the first load.

In an exemplary implementation, as shown in FIG. 4, application of the power output method for a generator to a generator is used as an example. For example, the following steps related to the power output method for a generator are included.
S201: When detecting that an energy storage device is connected and a first load is connected to the energy storage device, the generator obtains required power of the energy storage device, where the required power includes first load power and first battery pack power.
S202: Determine first remaining power based on rated generating power and the first load power, and send a second inquiry instruction to the energy storage device, where the second inquiry instruction is used to inquire whether the energy storage device consents to switching of the first battery pack power to the first remaining power.
S203: When receiving a second consent signal fed back by the energy storage device, generate power using the rated generating power as target generating power.
S204: When receiving a second rejection signal fed back by the energy storage device, generate power using the required power as target generating power.

As shown in FIG. 2 and FIG. 4, when the first load is connected to the energy storage device, the required power of the energy storage device includes the first load power and the first battery pack power. When the required power of the energy storage device is not the rated generating power of the generator, if the generator operates at the required power, it is likely to cause low fuel utilization of the generator and waste energy. In addition, when the first load is connected to the energy storage device, a user needs the energy storage device to charge the first load. In this case, the generator needs to preferentially meet a charging requirement of the first load when supplying power to the first load and the energy storage device. Therefore, the generator may determine the first remaining power based on the rated generating power of the generator and the first load power corresponding to the first load. Then, the generator sends the second inquiry instruction to the energy storage device, to inquire whether the energy storage device consents to switching of the first battery pack power to the first remaining power. If the energy storage device consents to switching of the first battery pack power to the first remaining power, the energy storage device feeds back the second consent signal to the generator, and the generator generates power using the rated generating power as the target generating power; or if the energy storage device rejects switching of the first battery pack power to the first remaining power, the energy storage device feeds back the second rejection signal to the generator, and the generator generates power using the required power as the target generating power.

The first remaining power is determined, and the second inquiry instruction, the second consent signal, and the second rejection signal are set, so that the energy storage device can select, based on the actual situation, to feed back the second consent signal or the second rejection signal corresponding to the second inquiry instruction to the generator, to flexibly select the target generating power of the generator, and then the generator can be controlled to operate at the target generating power required by the energy storage device and the first load. The method helps improve convenience in controlling the generator to operate at efficient operation power, and improve the fuel utilization to save energy and meet the charging requirements of the energy storage device and the first load, to improve experience in using the generator for the energy storage device.

For example, as shown in FIG. 2, the generator may be further configured to be connected to a device other than the energy storage device, for example, a second load. In some implementations, when the energy storage device and the second load are connected to the generator, the generator supplies power to the energy storage device through a direct current output port, and supplies power to the second load through an alternating current output port. For another example, the generator supplies power to the energy storage device through a direct current output port, and supplies power to the second load via the energy storage device. This is not limited herein. When the generator supplies power to the energy storage device and the second load, the generator not only needs to meet the required power of the energy storage device, but also needs to meet required power of the second load. The required power of the second load may be referred to as second load power corresponding to the second load.

For example, the energy storage device has an energy storage function, and the second load does not have an energy storage function. Therefore, when both the energy storage device and the second load are connected to the generator, the user is usually not so urgent to charge the energy storage device than the second load. Therefore, the generator needs to preferentially meet a charging requirement of the second load.

In some implementations, when it is detected that the second load is connected to the generator, the second load power corresponding to the second load is obtained, second remaining power is determined based on the rated generating power and the second load power, and a third inquiry instruction is sent to the energy storage device. The third inquiry instruction is used to inquire whether the energy storage device consents to switching of the required power to the second remaining power.

When detecting that the second load is connected to the generator, that is, detecting that both the energy storage device and the second load are connected to the generator, the generator needs to preferentially meet the charging requirement of the second load. In addition, to maximally control the generator to operate at the efficient operation power, actual required power of the energy storage device, for example, the second remaining power, during operation of the generator at the rated generating power, may be determined based on the rated generating power and the second load power. The second remaining power may include a second remaining power value, or may include a second remaining power range. This is not limited herein.

For example, the second remaining power may be obtained by subtracting the second load power from the rated generating power of the generator. Based on the determination of the second remaining power, the generator sends the third inquiry instruction to the energy storage device, to inquire whether the energy storage device consents to switching of the required power to the second remaining power. If the energy storage device consents to switching of the required power to the second remaining power, it indicates that the energy storage device may accept charging at the second remaining power. This indicates that a sum of the second load power and the required power is the rated generating power. The method helps control efficient operation power of the generator corresponding to a fuel-efficient operation region, improve the fuel utilization of the generator, and save energy.

The second remaining power is determined, and the third inquiry instruction is sent to the energy storage device, so that the energy storage device may select, based on an actual situation, whether to switch the required power to the second remaining power, helping improve convenience and flexibility in interaction for determining power for power supply to the energy storage device by the generator. In addition, the generator can subsequently determine power for power supply to the energy storage device and the second load based on the selection of the energy storage device, helping improve convenience in determining the power for power supply to the energy storage device and the second load by the generator.

In some implementations, when a third consent signal fed back by the energy storage device is received, power is generated using the rated generating power as the target generating power.

For example, when receiving the third inquiry instruction sent by the generator, the energy storage device may feed back information to the generator. The information fed back may include the third consent signal. The third consent signal is used to indicate that the energy storage device consents to switching of the required power to the second remaining power, indicating that the energy storage device may accept charging at the second remaining power.

For example, when receiving the third consent signal fed back by the energy storage device, the generator may switch the required power to the second remaining power, which is equivalent to that a sum of the second remaining power and the second load power is the rated generating power. In this case, the generator may determine that the target generating power is the rated generating power, and generate power at the rated generating power, to supply power to the energy storage device and the second load. Therefore, the generator can operate at the efficient operation power when supplying power to the energy storage device and the second load, helping improve the fuel utilization and save energy.

When receiving the third consent signal fed back by the energy storage device, the generator generates power using the rated generating power as the target generating power. Upon reception of the second consent signal, the generator may be controlled to generate power at the rated generating power, helping improve the convenience in controlling the generator to operate at the efficient operation power. In addition, the generator generates power using the rated generating power as the target generating power, helping improve the fuel utilization of the generator and save energy.

In some implementations, when a third rejection signal fed back by the energy storage device is received, power is generated using a sum of the required power and the second load power as the target generating power.

For example, when receiving the third inquiry instruction sent by the generator, the energy storage device may feed back information to the generator. The information fed back may include the third rejection signal. The third rejection signal is used to indicate that the energy storage device rejects switching of the required power to the second remaining power. The third rejection signal indicates that the energy storage device does not accept charging at the second remaining power. In this case, the generator needs to generate power using the sum of the required power and the second load power, to supply power to the energy storage device and the second load.

For example, the energy storage device feeds back the third rejection signal because the user has an urgent need to use the energy storage device and charging the energy storage device at low power cannot meet a requirement, or because the energy storage device cannot be charged at high power in a fully charged state or any state close to a fully charged state. When the generator receives the third rejection signal fed back by the energy storage device, the generator may determine that the target generating power includes the required power of the energy storage device and the second load power of the second load, for example, determine that the target generating power is the sum of the required power and the second load power, and generate power based on the sum of the required power and the second load power, to supply power to the energy storage device and the second load.

When receiving the third rejection signal fed back by the energy storage device, the generator generates power using the sum of the required power and the second load power as the target generating power, to supply power to the energy storage device and the second load. Upon reception of the third rejection signal, the generator may be controlled to generate power based on the sum of the required power and the second load power, helping meet the charging requirements of the energy storage device and the second load, to improve the experience in using the generator for the energy storage device and the second load.

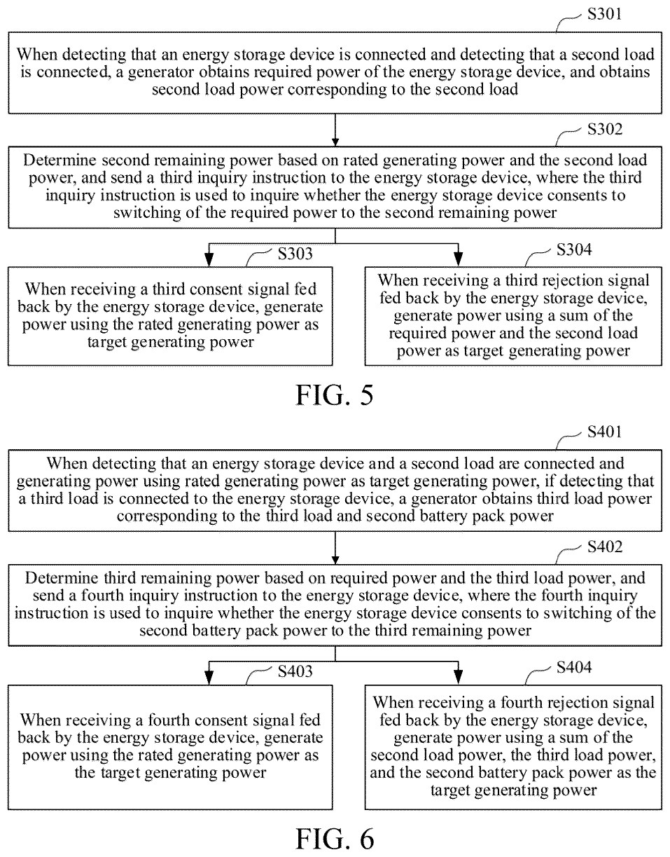

In an exemplary implementation, as shown in FIG. 5, application of the power output method for a generator to a generator is used as an example. For example, the following steps related to the power output method for a generator are included.
S301: When detecting that an energy storage device is connected and detecting that a second load is connected, the generator obtains required power of the energy storage device, and obtains second load power corresponding to the second load.
S302: Determine second remaining power based on rated generating power and the second load power, and send a third inquiry instruction to the energy storage device, where the third inquiry instruction is used to inquire whether the energy storage device consents to switching of the required power to the second remaining power.
S303: When receiving a third consent signal fed back by the energy storage device, generate power using the rated generating power as target generating power.
S304: When receiving a third rejection signal fed back by the energy storage device, generate power using a sum of the required power and the second load power as target generating power.

As shown in FIG. 2 and FIG. 5, both the energy storage device and the second load are connected to the generator, so that it may be determined that both the energy storage device and the second load have charging requirements. When the sum of the required power of the energy storage device and the second load power corresponding to the second load is not the rated generating power of the generator, if the generator directly generates power based on the sum of the required power and the second load power, it is likely to cause low fuel utilization of the generator and waste energy. In addition, when the second load is connected to the energy storage device, a charging requirement of a user for the second load is prior to a charging requirement of the user for the energy storage device, so that the charging requirement of the second load needs to be preferentially met. Therefore, the second remaining power may be determined based on the rated generating power of the generator and the second load power corresponding to the second load. The generator sends the third inquiry instruction to the energy storage device, to inquire whether the energy storage device consents to switching of the required power to the second remaining power. If consenting to switching of the required power to the second remaining power, the energy storage device feeds back the third consent signal to the generator. Then, the generator generates power using the rated generating power as the target generating power. In this case, the generator supplies power to the second load at the second load power, and supplies power to the energy storage device at the second remaining power. If rejecting switching of the required power to the second remaining power, the energy storage device feeds back the third rejection signal to the generator, and the generator may generate power using the sum of the required power and the second load power as the target generating power.

The second remaining power is determined, and the third inquiry instruction, the third consent signal, and the third rejection signal are set, so that the energy storage device can select, based on an actual situation, to feed back the third consent signal or the third rejection signal corresponding to the third inquiry instruction to the generator, to flexibly select the target generating power of the generator. According to the method, the generator may be controlled to operate at the target generating power required by the energy storage device and the second load, helping improve convenience in controlling the generator to operate at efficient operation power and improve fuel utilization. Therefore, energy is saved, and the charging requirements of the energy storage device and the second load are met to improve experience in using the generator for the energy storage device and the second load.

For example, as shown in FIG. 2, during a process in which the generator supplies power to a connected device, for example, the energy storage device and the second load, a third load may be connected to the energy storage device. In this case, the generator is generating power using the rated generating power as the target generating power. Because the generator has determined a ratio of generating power for the second load to generating power for the energy storage device, to maximally enable the generator to operate at efficient operation power corresponding to an efficient operation region, a ratio of generating power for the energy storage device to generating power for the third load needs to be determined based on the original required power of the energy storage device or the second remaining power. For example, after the third load is connected to the energy storage device, new required power of the energy storage device not only includes the required power of the energy storage device (for example, second battery pack power of a second battery pack), but also includes required power of the third load (for example, third load power).

For example, the required power of the energy storage device may be determined based on power of a battery pack in the energy storage device, so that the required power of the energy storage device may be referred to as the second battery pack power. Correspondingly, the required power of the third load may be referred to as the third load power.

In some implementations, when it is detected that the third load is connected to the energy storage device, the third load power corresponding to the third load and the second battery pack power are obtained. Then, the generator determines third remaining power based on the required power or the second remaining power (that is, power for charging the energy storage device when the third load is not connected) and the third load power, and sends a fourth inquiry instruction to the energy storage device. The third remaining power is obtained by subtracting the third load power from the required power or the second remaining power. The fourth inquiry instruction is used to inquire whether the energy storage device consents to switching of the second battery pack power to the third remaining power.

During a process in which the generator generates power using the rated generating power as the target generating power, to supply power to the energy storage device and the second load, if it is detected that the third load is connected to the energy storage device, that is, the energy storage device, the second load, and the third load are all connected to the generator, power needs to be supplied to the third load via the energy storage device, which is equivalent to that it may be determined that a charging requirement of the third load is prior to the charging requirement of the energy storage device. In this case, the generator needs to preferentially meet the charging requirement of the second load and the charging requirement of the third load. In addition, to maximally control the generator to operate at the efficient operation power, actual battery pack power of the energy storage device, for example, the third remaining power, during operation of the generator at the rated generating power, may be determined based on the required power of the energy storage device, that is, the second remaining power, and the third load power. The third remaining power may include a third remaining power value, or may include a third remaining power range. This is not limited herein.

For example, the third remaining power may be obtained by subtracting the third load power from the second remaining power or subtracting the third load power from the required power. Based on the determination of the third remaining power, the generator sends the fourth inquiry instruction to the energy storage device, to inquire whether the energy storage device consents to switching of the second battery pack power to the third remaining power. If the energy storage device consents to switching of the second battery pack power to the third remaining power, it indicates that a sum of the second battery pack power, the second load power, and the third load power is the rated generating power. The method helps control the efficient operation power of the generator corresponding to the fuel-efficient operation region, improve the fuel utilization of the generator, and save energy.

The third remaining power is determined, and the fourth inquiry instruction is sent to the energy storage device, so that the energy storage device may select, based on an actual situation, whether to switch the second battery pack power to the third remaining power, helping improve convenience and flexibility in interaction for determining power for power supply to the energy storage device by the generator. In addition, the generator can subsequently determine power for power supply to the energy storage device, the second load, and the third load based on the selection of the energy storage device, helping subsequently improve convenience in determining power for power supply to the energy storage device, the second load, and the third load by the generator.

In some implementations, when a fourth consent signal fed back by the energy storage device is received, power is generated using the rated generating power as the target generating power.

For example, when receiving the fourth inquiry instruction sent by the generator, the energy storage device may feed back information to the generator. The information fed back may include the fourth consent signal. The fourth consent signal is used to indicate that the energy storage device consents to switching of the second battery pack power to the third remaining power.

For example, when receiving the fourth consent signal fed back by the energy storage device, the generator may switch the second battery pack power to the third remaining power, which is equivalent to that a sum of the second load power, the third load power, and the second battery pack power is the rated generating power. In this case, the generator may determine that the target generating power is the rated generating power, and generate power at the rated generating power, to supply power to the energy storage device, the second load, and the third load. Therefore, the generator can operate at the efficient operation power when supplying power to the energy storage device, the second load, and the third load, helping improve the fuel utilization and save energy.

When the fourth consent signal fed back by the energy storage device is received, power is generated using the rated generating power as the target generating power. Upon reception of the fourth consent signal, the generator may be controlled to generate power at the rated generating power, helping improve convenience in controlling the generator to operate at the efficient operation power. In addition, the generator generates power using the rated generating power as the target generating power, helping improve the fuel utilization of the generator and save energy.

In some implementations, when a fourth rejection signal fed back by the energy storage device is received, power is generated using a sum of the second load power, the third load power, and the second battery pack power as the target generating power.

For example, when the energy storage device receives the fourth inquiry instruction sent by the generator, the energy storage device may feed back information to the generator. The information fed back may include the fourth rejection signal. The fourth rejection signal is used to indicate that the energy storage device rejects switching of the second battery pack power to the third remaining power.

For example, the energy storage device feeds back the fourth rejection signal to the generator because the user has an urgent need to use the energy storage device and charging the energy storage device at low power cannot meet a requirement, or because the energy storage device cannot be charged at high power in a fully charged state or any one state close to a fully charged state. When the generator receives the fourth rejection signal fed back by the energy storage device, the generator needs to meet the charging requirements of the energy storage device, the second load, and the third load, for example, determine that the target generating power is the sum of the second load power, the third load power, and the second battery pack power, and generate power based on the sum of the second load power, the third load power, and the second battery pack power, to supply power to the energy storage device, the second load, and the third load.

When receiving the fourth rejection signal fed back by the energy storage device, the generator generates power using the sum of the second load power, the third load power, and the second battery pack power as the target generating power, to supply power to the energy storage device, the second load, and the third load. Upon reception of the fourth rejection signal, the generator may be controlled to generate power based on the sum of the second load power, the third load power, and the second battery pack power, helping meet the charging requirements of the energy storage device, the second load, and the third load, to improve experience in using the generator for the energy storage device, the second load, and the third load.

In an exemplary manner, as shown in FIG. 6, application of the power output method for a generator to a generator is used as an example. For example, the following steps related to the power output method for a generator are included.
S401: When detecting that an energy storage device and a second load are connected and generating power using rated generating power as target generating power, if detecting that a third load is connected to the energy storage device, the generator obtains third load power corresponding to the third load and second battery pack power.
S402: Determine third remaining power based on required power and the third load power, and send a fourth inquiry instruction to the energy storage device, where the fourth inquiry instruction is used to inquire whether the energy storage device consents to switching of the second battery pack power to the third remaining power.
S403: When receiving a fourth consent signal fed back by the energy storage device, generate power using the rated generating power as the target generating power.
S404: When receiving a fourth rejection signal fed back by the energy storage device, generate power using a sum of the second load power, the third load power, and the second battery pack power as the target generating power.

As shown in FIG. 2 and FIG. 6, when both the energy storage device and the second load are connected to the generator, the third load is connected to the energy storage device. In this case, all of the energy storage device, the second load, and the third load have charging requirements. When the sum of the second battery pack power of the energy storage device, the second load power corresponding to the second load, and the third load power corresponding to the third load is not the rated generating power of the generator, if the generator directly operates based on the sum of the second battery pack power, the second load power, and the third load power, it is likely to cause low fuel utilization of the generator and waste energy. In addition, when the second load is connected to the generator, and the third load is connected to the energy storage device, a charging requirement of a user for the second load and a charging requirement of the user for the third load are prior to a charging requirement of the user for the energy storage device, so that the charging requirements of the second load and the third load need to be preferentially met. Therefore, the generator may determine the third remaining power based on the original required power of the energy storage device, that is, the second remaining power, and the third load power, and send the fourth inquiry instruction to the energy storage device, to inquire whether the energy storage device consents to switching of the second battery pack power to the third remaining power. If consenting to switching of the second battery pack power to the third remaining power, the energy storage device feeds back the fourth consent signal to the generator. The generator can generate power using the rated generating power as the target generating power. In this case, the generator supplies power to the second load at the second load power, supplies power to the third load at the third load power, and supplies power to a second battery pack at the third remaining power. If rejecting switching of the second battery pack power to the third remaining power, the energy storage device feeds back the fourth rejection signal to the generator, and the generator generates power using the sum of the second battery pack power, the second load power, and the third load power as the target generating power.

The third remaining power is determined, and the fourth inquiry instruction, the fourth consent signal, and the fourth rejection signal are set, so that the energy storage device can select, based on an actual situation, to feed back the fourth consent signal or the fourth rejection signal corresponding to the fourth inquiry instruction to the generator, to flexibly select the target generating power of the generator. According to the method, the generator may be controlled to operate at the target generating power required by the energy storage device, helping improve convenience in controlling the generator to operate at efficient operation power and improve fuel utilization. Therefore, energy is saved, and the charging requirements of the energy storage device, the second load, and the third load are met to improve experience in using the generator for the energy storage device.

For example, a power supply process of the generator may be controlled by the energy storage device or a device other than the energy storage device. For example, the generator may communicate with the energy storage device, and the generator may communicate with the device other than the energy storage device. For example, the energy storage device may supply power to a control circuit of the generator through a CAN bus, to maintain communication between the generator and the energy storage device and maintain communication between the generator and the device other than the energy storage device. In this way, the generator may receive power generation control instructions sent by the energy storage device and the device other than the energy storage device. The power generation control instruction may include a power generation stopping instruction or a power generation starting instruction.

In some implementations, when the power generation stopping instruction fed back by the energy storage device is received, the generator is controlled to stop generating power.

For example, when charging of the energy storage device is completed, the generator does not need to continue to charge the energy storage device. In this case, the energy storage device may feed back the power generation stopping instruction to the generator, and the generator may stop generating power according to the received power generation stopping instruction. For example, the user may send the power generation stopping instruction to the generator using an application, for example, an APP, and the generator may stop generating power according to the received power generation stopping instruction. The generator stops generating power according to the received power generation stopping instruction, helping improve convenience in controlling the generator to stop generating power.

In some implementations, when receiving the power generation starting instruction fed back by the energy storage device, the generator starts to generate power.

For example, when the energy storage device needs to be recharged, the energy storage device may feed back the power generation starting instruction to the generator, and the generator may start to generate power according to the received power generation starting instruction. For example, the user may send the power generation starting instruction to the generator using an application, for example, an APP, and the generator may start to generate power according to the received power generation starting instruction. The generator starts to generate power according to the received power generation starting instruction, helping improve convenience in controlling the generator to start to generate power.

For example, when it is detected that the energy storage device is connected to the generator, the required power of the energy storage device may change with power of a battery pack in the energy storage device. For example, as the generator supplies power to the energy storage device, the power of the battery pack in the energy storage device increases, and the required power of the energy storage device decreases. The required power of the energy storage device may also change with a load connection status of the energy storage device. For example, during a process in which the generator supplies power to the energy storage device, a first load or the third load is connected to the energy storage device. In this case, the required power of the energy storage device correspondingly increases, and an incremental part is, for example, first load power corresponding to the first load or the third load power corresponding to the third load.

In some implementations, as the required power of the energy storage device changes, the target generating power of the generator correspondingly changes.

For example, the required power of the energy storage device is obtained in real time, and whether the required power changes is detected. If the required power changes, the target generating power is redetermined.

When it is detected that the energy storage device is connected to the generator, the generator obtains the required power of the energy storage device in real time. When it is detected that the required power of the energy storage device changes, for example, the required power of the energy storage device decreases as the energy storage device gets close to a fully charged state, and the energy storage device cannot receive high charging power, the target generating power may be redetermined. For example, the target generating power is adjusted from the rated generating power to the required power of the energy storage device, so that the generator can flexibly respond to the required power of the energy storage device, improving flexibility of the generator in supplying power to the energy storage device.

When it is detected that the energy storage device is connected to the generator, and the first load is connected to the energy storage device, the generator obtains the required power of the energy storage device in real time. The first load may include a device with an intermittent operational capability, such as a refrigerator and an air conditioner. In this case, when it is detected that the required power of the energy storage device changes, the target generating power may be redetermined when, for example, the first load is switched from an operation suspended state to an operation resumed state. For example, a ratio, corresponding to the target generating power, of generating power for the energy storage device to generating power for the first load is adjusted. For another example, a corresponding inquiry instruction is sent to the energy storage device, and the target generating power is changed based on a corresponding consent signal or rejection signal fed back by the energy storage device. Therefore, the generator can flexibly respond to the required power of the energy storage device, improving flexibility of the generator in supplying power to the energy storage device and the first load.

Certainly, a manner for redetermining the target generating power is not limited thereto. For example, when it is detected that the energy storage device is connected to the generator and that the second load is connected to the generator, the generator may obtain the second load power corresponding to the second load in real time, and detect whether the second load power changes and whether the required power of the energy storage device changes. When at least one of the second load power and the required power changes, the target generating power of the generator is redetermined based on the rated generating power, the second load power, and the required power.

The required power of the energy storage device is obtained in real time, and the target generating power is redetermined when it is detected that the required power changes. This helps adjust the target generating power of the generator in time, so that the generator can flexibly respond to the required power of the energy storage device, improving the flexibility of the generator in supplying power to the energy storage device.

For example, the generating power using the rated generating power as the target generating power includes: controlling the generator to generate power at the target generating power, and adjusting the target generating power based on requirement information of a device connected to the generator, where the requirement information includes safe charging power, a safe charging voltage, and a safe charging current.

For example, when the energy storage device is connected to the generator, and the generator generates power using the rated generating power as the target generating power, for example, the required power of the energy storage device needs to be switched to the rated generating power. However, to ensure charging safety of the energy storage device, for example, the energy storage device is set with requirement information, where the requirement information is used to indicate safe charging power, a safe charging voltage, and a safe charging current that can be accepted by the energy storage device while the charging safety is ensured. In this case, the generator adjusts the target generating power based on the requirement information of the energy storage device when supplying power to the energy storage device. For example, when the rated generating power is greater than the safe charging power, the target generating power of the generator may be adjusted to the safe charging power. For another example, a device such as the first load, the second load, and the third load may be further connected to the generator, and when the rated generating power is greater than the safe charging power of the energy storage device, a ratio of generating power for the energy storage device to generating power for the device such as the first load, the second load, and the third load may be adjusted, so that the required power of the energy storage device is the safe charging power.

Similarly, when the device connected to the generator, for example, the first load, the second load, the third load, and another device, is set with the requirement information, the target generating power of the generator may be adjusted based on the requirement information of the device connected to the generator. Details are not described herein again.

The generator is controlled to generate power at the target generating power, and the target generating power is adjusted based on the requirement information of the device connected to the generator. This helps control the generator to operate at the efficient operation power while ensuring the charging safety of the device connected to the generator.

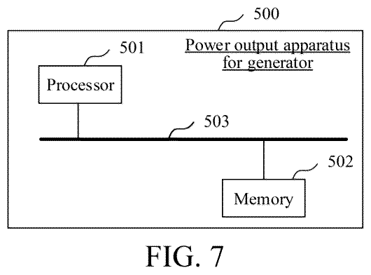

Refer to FIG. 7 in conjunction with the foregoing embodiment. FIG. 7 is a schematic block diagram of a power output apparatus 500 for a generator according to an embodiment of the present application. The power output apparatus 500 for a generator may be disposed in a generator. The power output apparatus 500 includes a processor 501 and a memory 502.

For example, the processor 501 and the memory 502 are connected through a system bus 503. The system bus 503 is, for example, an inter-integrated circuit (I2C) bus.

Specifically, the processor 501 may be a micro-controller unit (MCU), a central processing unit (CPU), a digital signal processor (DSP), or the like.

Specifically, the memory 502 may be a flash chip, a read-only memory (ROM), a magnetic disk, an optical disk, a USB drive, a mobile hard disk drive, or the like.

The processor 501 is configured to run a computer program stored in the memory 502, and implement the foregoing power output method for a generator when executing the computer program.

For example, the processor 501 is configured to run a computer program stored in the memory 502, and implement the steps of the foregoing power output method for a generator when invoking the computer program.

A specific principle and an implementation of the power output apparatus for a generator provided in this embodiment of the present application are similar to those of the power output method for a generator in the foregoing embodiment, and details are not described herein again.

For example, an embodiment of the present application further provides a generator. The generator includes the power output apparatus 500 for a generator in the foregoing embodiment. The generator may be a device including a power generation function and a power supply function. For example, the generator includes a permanent magnet generator, a wind generator, and a hydroelectric generator. This is not limited herein.

For example, the generator is configured to implement the steps of the foregoing power output method for a generator.

A specific principle and an implementation of the generator provided in this embodiment of the present application are similar to those of the power output method for a generator in the foregoing embodiment, and details are not described herein again.

For example, an embodiment of the present application further provides a power generation and energy storage system. The power generation and energy storage system includes an energy storage device and the foregoing generator. The generator is electrically connected to the energy storage device, and is configured to charge the energy storage device.

For example, the power generation and energy storage system is configured to implement the steps of the foregoing power output method for a generator.

A specific principle and an implementation of the power generation and energy storage system provided in this embodiment of the present application are similar to those of the power output method for a generator in the foregoing embodiment, and details are not described herein again.

For example, an embodiment of this disclosure further provides a computer-readable storage medium. The computer-readable storage medium stores a computer program. When the computer program is invoked by a processor, the processor is enabled to implement the steps of the power output method for a generator provided in the foregoing embodiment.

The computer-readable storage medium may be an internal storage unit of the power output apparatus for a generator, the generator, or the power generation and energy storage system according to any one of the foregoing embodiments, for example, a hard disk drive or an internal memory of the power output apparatus for a generator, a hard disk drive or an internal memory of the generator, and a hard disk drive or an internal memory of the power generation and energy storage system. Alternatively, the computer-readable storage medium may be an external storage device of the power output apparatus for a generator, the generator, or the power generation and energy storage system, for example, a plug-in hard disk drive, a smart media card (SMC), a secure digital (SD) card, or a flash card on the power output apparatus for a generator.

It should be understood that terms used in the present application are only for the purpose of describing specific embodiments, and are not intended to limit the present application.

It should be further understood that, the term “and/or” used in the present application and the appended claims refers to and includes any combination and all possible combinations of one or more of the associated listed items.

The foregoing descriptions are merely specific implementations of the present application, but are not intended to limit the protection scope of the present application. Any equivalent modification or replacement readily figured out by a person skilled in the art within the technical scope disclosed in the present application shall fall within the protection scope of the present application. Therefore, the protection scope of the present application shall be subject to the protection scope of the claims.

What is claimed is:

1. A power output method for a generator, comprising:
when it is detected that an energy storage device is connected to a generator, obtaining required power of the energy storage device;
sending a first inquiry instruction to the energy storage device, wherein the first inquiry instruction is used to inquire whether the energy storage device consents to switching of the required power to rated generating power, the rated generating power being corresponding power used when fuel utilization of the generator reaches preset fuel utilization; and
when receiving a first consent signal fed back by the energy storage device, generating power using the rated generating power as target generating power, to supply power to the energy storage device; or
when receiving a first rejection signal fed back by the energy storage device, generating power using the required power as target generating power, to supply power to the energy storage device.

2. The method according to claim 1, further comprising:
if the required power comprises first load power and first battery pack power, determining first remaining power based on the rated generating power and the first load power, and sending a second inquiry instruction to the energy storage device, wherein the second inquiry instruction is used to inquire whether the energy storage device consents to switching of the first battery pack power to the first remaining power; and
when receiving a second consent signal fed back by the energy storage device, generating power using the rated generating power as the target generating power; or
when receiving a second rejection signal fed back by the energy storage device, generating power using the required power as the target generating power.

3. The method according to claim 1, further comprising:
when it is detected that a second load is connected to the generator, obtaining second load power corresponding to the second load, determining second remaining power based on the rated generating power and the second load power, and sending a third inquiry instruction to the energy storage device, wherein the third inquiry instruction is used to inquire whether the energy storage device consents to switching of the required power to the second remaining power; and
when receiving a third consent signal fed back by the energy storage device, generating power using the rated generating power as the target generating power; or
when receiving a third rejection signal fed back by the energy storage device, generating power using a sum of the required power and the second load power as the target generating power.

4. The method according to claim 3, wherein after generating the power using the rated generating power as the target generating power, the method further comprises:
when it is detected that a third load is connected to the energy storage device, obtaining third load power corresponding to the third load and second battery pack power, determining third remaining power based on the required power and the third load power, and sending a fourth inquiry instruction to the energy storage device, wherein the fourth inquiry instruction is used to inquire whether the energy storage device consents to switching of the second battery pack power to the third remaining power; and
when receiving a fourth consent signal fed back by the energy storage device, generating power using the rated generating power as the target generating power; or
when receiving a fourth rejection signal fed back by the energy storage device, generating power using a sum of the second load power, the third load power, and the second battery pack power as the target generating power.

5. The method according to claim 1, further comprising:
when receiving a power generation stopping instruction fed back by the energy storage device, controlling the generator to stop generating power.

6. The method according to claim 1, further comprising:
obtaining the required power of the energy storage device in real time, and detecting whether the required power changes; and
if the required power changes, redetermining the target generating power.

7. The method according to claim 1, wherein generating the power using the rated generating power as the target generating power comprises:
controlling the generator to generate power at the target generating power, and adjusting the target generating power based on requirement information of a device connected to the generator, wherein the requirement information comprises safe charging power, a safe charging voltage, and a safe charging current.

8. A power output apparatus for a generator, comprising one or more processors and a memory, wherein the memory stores a computer program that, when being executed, causes the one or more processors to perform the power output method according to claim 1.

9. A generator, comprising the power output apparatus according to claim 8.

10. A power generation and energy storage system, comprising an energy storage device and the generator according to claim 9, wherein
the generator is electrically connected to the energy storage device, and is configured to charge the energy storage device.
